(19) United States
(12) Patent Application Publication
(10) Pub. No.: US 2026/0337476 A1
(43) Pub. Date: Oct. 29, 2026

(54) MULTIFUNCTIONAL TREATMENT FLUID PACKAGES, AND RELATED TREATMENT FLUIDS AND METHODS

(71) Applicant: Schlumberger Technology Corporation, Sugar Land, TX (US)

(72) Inventors: Juan David ESTRADA BENAVIDES, Katy, TX (US); Javier SANCHEZ REYES, Sugar Land, TX (US); Oscar RINCON ORTIZ, Sugar Land, TX (US); Rasika PRABHU, Sugar Land, TX (US)

(21) Appl. No.: 19/123,431

(22) PCT Filed: Dec. 6, 2024
(86) PCT No.: PCT/US2024/058925

§ 371 Date: Apr. 23, 2025

Related U.S. Application Data
(60) Provisional application No. 63/607,302, filed on Dec. 7, 2023.

(51) Int. Cl. C09K 8/64; C09K 8/52; C09K 8/60; C09K 8/80; C09K 8/82; E21B 37/06; E21B 43/267

(52) U.S. Cl. CPC C09K 8/64; C09K 8/52; C09K 8/605; C09K 8/80; C09K 8/82; E21B 37/06; E21B 43/267; C09K 2208/10; C09K 2208/28

(57) ABSTRACT

Certain embodiments of the present disclosure include techniques for preparing a multifunctional treatment fluid package and usage thereof in one or more wellsite operations. A method of providing a multifunctional treatment fluid package to a wellbore includes providing a multifunctional treatment fluid package to a wellsite, mixing the multifunctional treatment fluid package with a fluid to form a treatment fluid, and circulating the treatment fluid to a wellbore extending through a subterranean formation. The multifunctional treatment fluid package includes a friction reducer package, a biocide, and a scale inhibitor treatment fluids and multifunctional treatment fluid packages are also disclosed.

### CROSS REFERENCE TO RELATED APPLICATIONS

This application claims priority to and the benefit of United States Provisional Application Ser. No. 63/607,302, filed on Dec. 7, 2023, entitled “Techniques for Providing a Multifunctional Treatment Fluid and Usage Thereof,” the disclosure of which is hereby incorporated herein in its entirety by this reference.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

In order to facilitate the recovery of hydrocarbons from oil and gas wells, subterranean formations surrounding such wells can be hydraulically fractured. Hydraulic fracturing may be used to create cracks or fractures in subsurface formations to allow oil and gas to move toward the well. A formation is fractured by introducing a specially engineered fluid (e.g., a treatment fluid or a fracturing fluid) into the formation through one or more wellbores.

Conventional treatment fluids are typically either delivered to a wellsite after being prepared at a facility elsewhere, or prepared at the wellsite after additives of the treatment fluids are delivered to the wellsite. However, the cost of purchasing and transporting such fluids and additives is high. In particular, the treatment fluids and/or the additives thereof are typically delivered from facilities hundreds or even thousands of miles away from the wellsite. Additionally, such treatment fluids and/or additives are transported using solvents, which typically account for 70% or more of the volume of the treatment fluids and/or additives delivered to the wellsite. This amount of solvent compounds with each additive delivered to the wellsite, thereby increasing the cost of purchasing and transporting additives to the wellsite to mix a treatment fluid. Accordingly, providing an improved treatment fluid at a wellsite that decreases the cost of such operations is desirable.

### BRIEF SUMMARY

A summary of certain embodiments described herein is set forth below. It should be understood that these aspects are presented merely to provide the reader with a brief summary of these certain embodiments and that these aspects are not intended to limit the scope of this disclosure.

Certain embodiments of the present disclosure include techniques for preparing a multifunctional treatment fluid and usage thereof in one or more wellsite operations. The multifunctional treatment fluid may include one or more additives having two or more characteristics of conventional additives in conventional treatment fluids. In certain embodiments, the multifunctional treatment fluid may include a single additive that has a number of characteristics that would typically belong to a number of different conventional additives in a conventional treatment fluid. Raw materials for the multifunctional treatment fluid may be transported from within a basin to a facility nearby a wellsite for processing and/or stabilization. Thereafter, the multifunctional treatment fluid may be transported as a single product to the wellsite for use in one or more wellsite operations.

In some embodiments, a method of providing a multifunctional treatment fluid package to a wellbore comprises providing a multifunctional treatment fluid package to a wellsite, mixing the multifunctional treatment fluid package with a fluid to form a treatment fluid, and circulating the treatment fluid to a wellbore extending through a subterranean formation. The multifunctional treatment fluid package comprises a friction reducer package, a biocide, and a scale inhibitor. The friction reducer package comprises greater than about 70.0 volume percent of a friction reducer comprising polyacrylamide, nanoparticles, and a suspension package comprising an organic oil including one or more fatty acids.

In some embodiments, a treatment fluid for treating a wellbore comprises a base fluid and a multifunctional treatment fluid package comprising a friction reducer package comprising greater than about 70.0 volume percent of a friction reducer comprising polyacrylamide, nanoparticles, and a suspension package comprising an organic oil including one or more fatty acids. The multifunctional treatment fluid package further comprises a biocide, and a scale inhibitor.

In some embodiments, a multifunctional treatment fluid package for use in a wellbore treatment fluid comprises a friction reducer package comprising greater than about 70.0 volume percent of a friction reducer comprising polyacrylamide, nanoparticles, and a suspension package comprising an organic oil including one or more fatty acids. The multifunctional treatment fluid package further comprises a biocide, and a scale inhibitor.

Although certain embodiments disclosed herein are described with reference to treatment fluids and/or additives of treatment fluids, it should be understood that such embodiments are not limited in application as such. In particular, the embodiments disclosed herein may be used for other types of fluids or materials that are used in operations at a wellsite.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter. This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 shows a graphical flowchart of conventional techniques for transporting raw materials of treatment fluid to a facility for storage, mixing of the raw materials at the facility to provide the treatment fluid, and transporting of the treatment fluid to a basin and/or one or more wellsites; and

FIG. 2 shows a graphical flowchart of techniques for providing a multifunctional treatment fluid to a wellsite for use in one or more wellsite operations, in accordance with certain embodiments of the present disclosure;

FIG. 3 is a simplified representation of a system including a wellbore extending through an earth formation, according to at least one embodiment of the present disclosure; and

FIG. 4 is a simplified flow diagram of a method of treating a wellbore and/or earth formation with a treatment fluid, according to at least one embodiment of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.” As used herein, the terms “up” and “down,” “uphole” and “downhole”, “upper” and “lower,” “top” and “bottom,” and other like terms indicating relative positions to a given point or element are utilized to more clearly describe some elements. Commonly, these terms relate to a reference point as the surface from which drilling operations are initiated as being the top (e.g., uphole or upper) point and the total depth along the drilling axis being the lowest (e.g., downhole or lower) point, whether the well (e.g., wellbore, borehole) is vertical, horizontal or slanted relative to the surface.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

The present disclosure generally relates to techniques for providing a multifunctional treatment fluid and usage thereof in one or more wellsite operations. As mentioned above, conventional treatment fluids are typically either delivered to a wellsite after being prepared at a facility elsewhere, or prepared at the wellsite after additives of the treatment fluids are delivered to the wellsite. However, the cost of purchasing and transporting such fluids and additives is high. For example, additives blended in wellbore fluids may be transported to a wellsite in a drum or other container. However, some additives may have flowability issues at conditions that may be present at the wellsite (e.g., at the ambient temperatures at the wellsite) and/or may include materials exhibiting a viscosity making it difficult to remove the additives from the container. Accordingly, such additives are generally dissolved in a solvent or other carrier fluid to reduce the pour point and/or increase the flowability of the additives when it is desired to remove the additive from the container into a wellbore fluid.

According to embodiments described herein, a multifunctional treatment fluid package is provided to a wellbore and/or subterranean formation for performing one or more wellbore operations, such as one or more of hydraulic fracturing, stimulation, completion operations, workover operations, or another wellbore operation. The wellbore may extend through a subterranean earth formation and may be configured to facilitate, for example, production of hydrocarbons, sequestration of carbon dioxide, or other operations. The multifunctional treatment fluid package may include a mixture of additives for facilitating the wellbore operation. The multifunctional treatment fluid package may include a plurality of materials, each of which may be formulated and configured for performing one or more functions in the wellbore and/or the earth formation. The additives may be provided together in the multifunctional treatment fluid package. Accordingly, the multifunctional treatment fluid package including the plurality of additives may include a higher volume percent of active components and a lower volume percent of solvents or other materials used for delivery of the active components compared to additives that are provided (e.g., delivered) to a wellsite and/or wellbore separately.

The multifunctional treatment fluid package may include a plurality of additives. The multicomponent treatment fluid package including each of the additives may be mixed with a base fluid to form a wellbore fluid (also referred to herein as a “treatment fluid”). A volume percent of active components in the multifunctional treatment fluid package may be greater than about 60.0 volume percent, such as greater than about 70.0 volume percent, or greater than about 80.0 volume percent.

The multifunctional treatment fluid package may include a friction reducer package (including a friction reducer, nanoparticles, and a suspension package), a biocide, and a scale inhibitor. Each of the components of the multifunctional treatment fluid package may be compatible with one another such that they may be packaged and transported (e.g., in a drum and/or container) to the wellsite together as a single package. In addition, the components of the multifunctional treatment fluid package may be circular. For example, the components of the multifunctional treatment fluid package may be one or more of environmentally friendly, renewable, and/or formed from waste products of industrial processes. The friction reducer package may include a friction reducer, nanoparticles, and a suspension package carrying the friction reducer and the nanoparticles to facilitate a flowability of the friction reducer and the nanoparticles in the friction reducer package and the multifunctional treatment fluid package. The suspension package may include a naturally occurring material, may be biodegradable, and may include a renewable material. In addition, the scale inhibitor may exhibit synergistic properties with the friction reducer and may not increase or substantially increase the drag of the friction reducer.

The multifunctional treatment fluid package may be mixed with a base fluid at the wellbore to form a treatment fluid, which may also be referred to as a wellbore fluid. The treatment fluid may be introduced (e.g., circulated) to the wellbore and/or the subterranean formation through the wellbore. In some embodiments, the treatment fluid is introduced to the wellbore and subterranean formation during a hydraulic fracturing process and the treatment fluid includes a hydraulic fracturing fluid. The multicomponent treatment fluid package may facilitate reducing mixing of additives at the wellsite and may facilitate improved delivery of the additives to the base fluid to form the treatment fluid at the wellsite compared to the separate addition of multiple additives to a base fluid. Further, the multifunctional treatment fluid package may be provided to a wellsite and exhibit a substantially higher volume percent of active components compared to conventional additives provided to wellbore fluids.

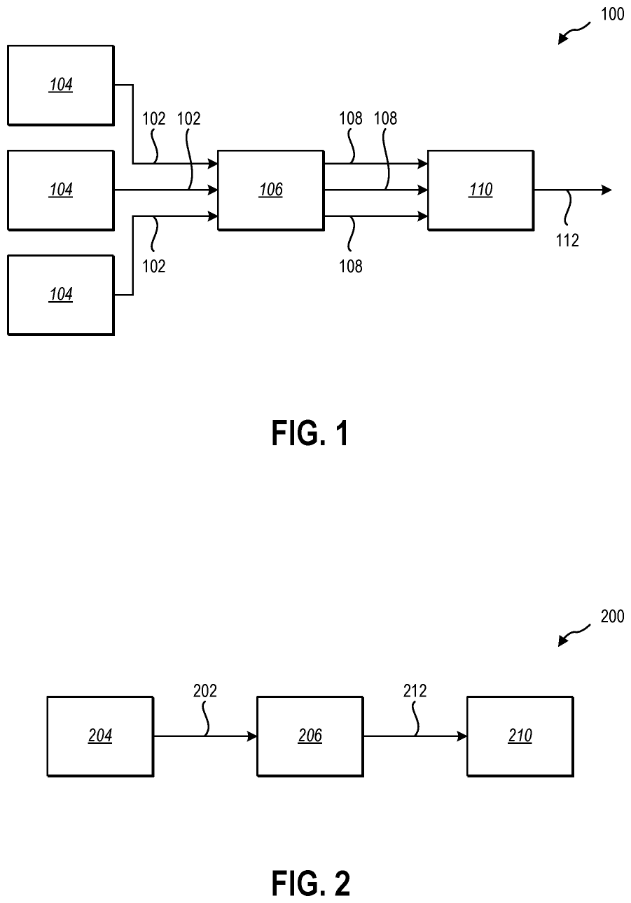

FIG. 1 shows a graphical flowchart 100 of a conventional technique for transporting raw materials 102 including one or more additives (that will be used to form a treatment fluid 112) from one or more remote locations 104 to a facility 106 for storage and/or mixing, mixing the raw materials 102 at the facility 106 to provide transport packages 108 that are, in turn, transported to a basin and/or one or more wellsites 110 to form the treatment fluid 112 for use. In particular, after a raw material 102 is purchased, the raw material 102 for each additive of the treatment fluid 112 is transported to the facility 106 for storage and/or preparation of the transport package 108. Typically, such facilities 106 are remote from the basin and/or one or more wellsites 110 such that the raw materials 102 may be transported over hundreds or even thousands of miles from their source (from the remote locations 104). Once the raw materials 102 for each additive of the treatment fluid 112 arrives at the facility 106, the facility 106 may unload and store the raw materials 102. In certain situations, individual transport packages 108 (e.g., the additive dissolved in a carrier fluid or a solvent) may be prepared at the facility 106 for each additive of the treatment fluid 112 for transport to the basin and/or wellsites 110. In other words, each raw material 102 to the wellsite 110 may be provided to the wellsite 110 in an individual transport package 108 including a carrier fluid (e.g., a solvent) in which the active component is dissolved. The treatment fluid 112 may then be prepared at the basin and/or wellsites 110 by processing the received transport packages 108 for each of the additives. In other situations, the treatment fluid 112 may be prepared at the facility 106 or at another facility using the raw materials 102 for each additive before being transported to the basin and/or wellsites 110 for use. In any case, the transport packages 108 for each of the additives of the treatment fluid 112 are then transported to the basin and/or wellsites 110 for use. When compounded over each step of the aforementioned techniques, the cost of transporting, storage, and preparation of the treatment fluid 112 exponentially increases, particularly as the number of additives in the treatment fluid 112 increases.

Accordingly, embodiments of the present disclosure are directed to various techniques for providing a multifunctional treatment fluid package to a wellsite for use in one or more wellsite operations that decreases the cost of transporting, storing, and preparing the treatment fluid package in comparison to the conventional techniques described above. In some embodiments, the multifunctional treatment fluid package (which may also be referred to herein as a “treatment fluid package”) may include a single additive that provides the same functional characteristics as two or more additives in conventional treatment fluids. For instance, the additive may have two or more of the following characteristics: a friction reducer, a gelling agent, an acid retarding agent, an iron-reducing agent, a non-emulsifying agent, a surfactant, an inhibitor aid, a corrosion inhibitor, or any other suitable characteristic, or a combination thereof. In this way, the multifunctional treatment fluid may be prepared from less additives, thereby reducing the cost of transporting, storage, and processing such additives to provide the multifunctional treatment fluid at a wellsite. In certain embodiments, the multifunctional treatment fluid package may be prepared from a single additive that has a number of different characteristics of conventional additives typically used to provide a conventional treatment fluid. Additionally, or alternatively, the single additive may be transported in a dry state (i.e., without being dissolved in solvent), thereby reducing cost in transport and subsequent processing.

In some embodiments, the multifunctional treatment fluid package includes more than one additive and exhibits multiple functionalities. For example, each additive may be formulated and configured to impart one or more desired functionalities (properties) to the multifunctional treatment fluid. The multifunctional treatment fluid package may include, for example, a friction reducer, a biocide, and a scale inhibitor. In some embodiments, the multifunctional treatment fluid package includes a plurality of additives, each of which may be dispersed, dissolved, and/or carried by a carrier fluid which may be common to all of the additives. In other words, each additive may not be carried by a separate carrier fluid; rather, the multifunctional treatment fluid package may include a plurality of additives, each of which may share and be compatible with a common carrier fluid (e.g., solvent). The multifunctional treatment fluid package may be provided to a wellsite as a mixture including each of the additives in a single material (e.g., a single fluid) and may be mixed with a base fluid to form a treatment flid including the multifunctional treatment fluid package. Accordingly, the multifunctional treatment fluid package may be provided to the wellbore and circulated through the wellbore and/or subterranean formation as a single fluid with a single carrier fluid (e.g., each additive may not be carried in a separate carrier fluid). Since each of the additives are in the same fluid, the additives may be formulated and configured to be compatible with one another and with the carrier fluid to facilitate packaging, transport, and delivery of the multifunctional treatment fluid to the wellsite, and from the packaging to the wellbore (e.g., to a wellbore fluid).

With the foregoing in mind, FIG. 2 shows a graphical flowchart 200 of techniques for providing a multifunctional treatment fluid package 212 and transporting the multifunctional treatment fluid package 212 fluid to a wellsite 210, in accordance with certain embodiments of the present disclosure. As illustrated in FIG. 2, raw material 202 (e.g., the multifunctional additive) for the multifunctional treatment fluid package 212 may be purchased within a basin 204 in which a target wellsite 210 is located. The raw material 202 may then be transported to a facility 206 within the basin 204 near the wellsite 210 (e.g., within 100 miles of the wellsite 210). In this way, the transportation costs of the raw material 202 are minimized as compared to transporting raw material 202 over hundreds or thousands of miles during conventional techniques described with reference to FIG. 1 above. Additionally, after arriving at the facility 206 near the wellsite 210, the multifunctional treatment fluid package 212 may be prepared by concentrating and stabilizing the raw materials 202 (e.g., the multifunctional additive). Thereafter, the multifunctional treatment fluid package 212 may be transported from the facility 206 to the wellsite 210 for use in one or more wellsite operations.

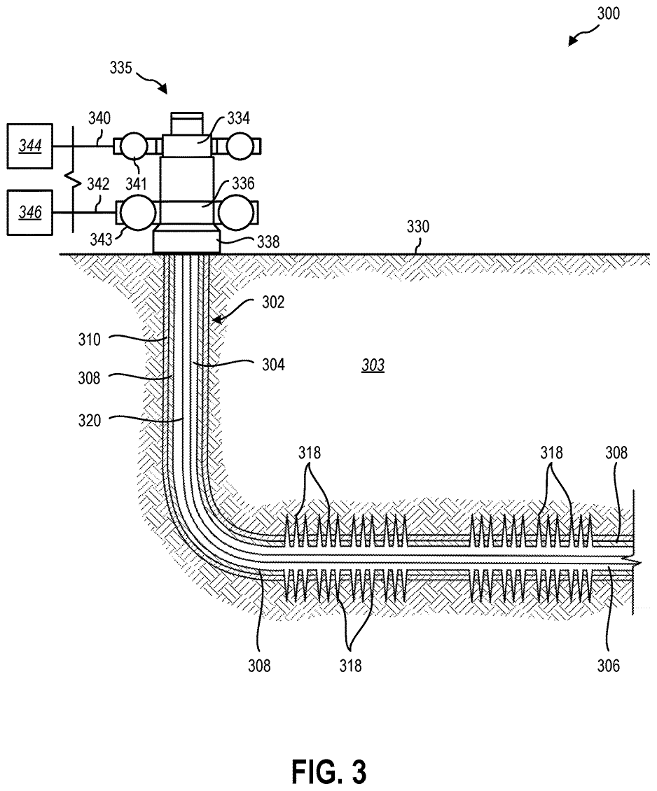

As described above, in some embodiments, the multifunctional treatment fluid may be circulated to a wellbore extending through an earth formation. FIG. 3 is a simplified representation of a system 300 including a wellbore 302 extending through an earth formation 303 (also referred to as a subterranean formation), according to at least one embodiment of the present disclosure. The wellbore 302 may include a vertical portion 304 and a horizontally-extending or deviated portion 306. The wellbore 302 may have been previously formed by one or more drilling operations, followed by casing the wellbore 302 with casing 308. In some embodiments, the casing 308 or at least a portion of the casing 308 may be cemented with cement 310.

In some embodiments, sections of the wellbore 302, the casing 308, the earth formation 303, and/or the cement 310 may have been previously perforated and may include perforations 318 extending at least partially into the earth formation 303. In some embodiments, after forming the perforations 318, the wellbore 302 may be prepared for additional treatments. In some embodiments, the treatment fluids described herein may be circulated through the wellbore 302, such as after perforations 318 have been formed in the earth formation 303.

In some embodiments, a tubing 320 (e.g., coiled tubing) or production piping is lowered into the wellbore 302 and the treatment fluid is provided to the wellbore 302 via the tubing 320. In other embodiments, the treatment fluid is provided to the wellbore 302 through the casing 308.

At a surface 330, the wellbore 302 may be capped by a plurality (e.g., a stack) of fluid flow control system 335, such as a so-called “Christmas tree” or a “frac tree.” The fluid flow control system 335 may include flow control valves (e.g., master valves, wing valves, swab valves, etc.), spools, flow crosses (e.g., goat heads, frac heads, etc.), and fittings individually and/or collectively configured to direct and control (e.g., permit and prevent) flow of the treatment fluid into the wellbore 302 and to direct and control flow of formation fluids out of the wellbore 302.). For example, the fluid flow control system 335 may include at least a first flow control device 334 and a second flow control device 336. The first flow control device 334 and the second flow control device 336 may individually include a valve. The first flow control device 334 and the second flow control device 336 may be configured to close selected tubulars or pipes, such as the casing 308 or tubing 320 extending within the wellbore 302, to selectively facilitate the flow of various fluids to or from the wellbore 302. In some embodiments, the fluid flow control system 335 includes a blow-out preventer (BOP) stack configured to selectively prevent the flow of formation fluids out of the wellbore 302. The fluid flow control system 335 may be directly or indirectly coupled to the top of a wellhead 338 (e.g., tubing head adapter) terminating the wellbore 302 at the surface 330.

In some embodiments, the first flow control device 334 is operably coupled to and in fluid communication with a first fluid conduit 340 and the second flow control device 336 is operably coupled to and in fluid communication with a second flow conduit 342 to facilitate selective fluid connection between various fluids and the wellbore 302. For example, the first flow control device 334 may be in fluid communication with the first fluid conduit 340 via a first valve 341 and the second flow control device 336 may be in fluid communication with the second fluid conduit 342 via a second valve 343. The first flow control device 334 and the first fluid conduit 340 may be in fluid communication with a first pump 344; and the second flow control device 336 and the second fluid conduit 342 may be in fluid communication with a second pump 346.

In some embodiments, one or more fluids may be provided to the wellbore 302 and/or the earth formation 303 through the first fluid conduit 340 and/or the second fluid conduit 342. The fluid may include one or more of a pumpdown fluid, an acid (e.g., a spearhead treatment), a stimulation fluid, a completion fluid, a fracturing fluid, a corrosion inhibitor composition, another fluid to be provided to the wellbore 302, or combinations thereof.

In some embodiments, one or more wellbore fluids are provided to the wellbore 302 and/or the earth formation 303 through the first fluid conduit 340 and/or the second fluid conduit 342. In some embodiments, the wellbore fluid includes a hydraulic fracturing fluid. The wellbore fluid may include a base fluid and a multifunctional treatment fluid package including one or more additives formulated and configured to impart different functionalities to the treatment fluid. The wellbore fluid may also be referred to herein as a “treatment fluid.”

The base fluid may include water, brine, methanol, or another fluid configured to carry components of the treatment fluid (e.g., sand, proppants). In some embodiments, the base fluid includes water or brine. In embodiments in which the base fluid includes brine, the base fluid may include one or more of sodium chloride, calcium chloride, potassium chloride, magnesium chloride, zinc bromide, and/or other salts.

The base fluid may constitute from about 90.0 volume percent to about 99.5 volume percent of the treatment fluid, such as from about 90.0 volume percent to about 92.0 volume percent, from about 92.0 volume percent to about 94.0 volume percent, from about 94.0 volume percent to about 96.0 volume percent, from about 96.0 volume percent to about 98.0 volume percent, from about 98.0 volume percent to about 99.0 volume percent, or from about 99.0 volume percent to about 99.5 volume percent of the treatment fluid. However, the disclosure is not so limited, and the base fluid may constitute a different amount of the treatment fluid that that described.

In some embodiments, the treatment fluid further includes one or more proppants configured to form fractures in the earth formation 303. For example, when the treatment fluid is circulated through the wellbore 302 above a hydraulic fracturing pressure, the proppants may enter the perforations 318 and may open fractures in the earth formation 303. When the hydraulic fracturing pressure is removed, the proppants may remain in the fractures facilitating the flow of formation fluids through the fractures and the perforations to the wellbore 302 (e.g., to a production string).

The proppants may include solid particles including sand, sintered bauxite, ceramic materials, resin-coated sand, or other particles sized, shaped, and configured to enter the fractures and maintain an open position of the fractures after the earth formation 303 and fractures are no longer exposed to the high pressures of the fracturing fluid. The solid particles may be sized and shaped to facilitate maintaining the openings in the fractures after the fracturing fluid is no longer circulated to the wellbore 302.

The proppant may constitute from about 0.5 weight percent to about 10.0 weight percent of the treatment fluid, such as from about 0.5 weight percent to about 1.0 weight percent, from about 1.0 weight percent to about 2.0 weight percent, from about 2.0 weight percent to about 4.0 weight percent, from about 4.0 weight percent to about 6.0 weight percent, from about 6.0 weight percent to about 8.0 weight percent, or from about 8.0 weight percent to about 10.0 weight percent of the treatment fluid. However, the disclosure is not so limited, and the proppant may constitute a different amount of the treatment fluid. In some embodiments, during the fracturing operation, a concentration of the proppant may be increased. For example, a concentration of the proppant in the treatment fluid may increase as the fracturing operation progresses.

As described above, the treatment fluid may further include one or more additives, which may be provided in the form of the multifunctional treatment fluid package. The multifunctional treatment fluid package may also be referred to herein as a “treatment fluid package.” The treatment fluid package may include one or more additives formulated and configured to provide desired properties and/or functionalities to the treatment fluid. The additives may be present in the treatment fluid package prior to mixing the treatment fluid package with the base fluid to form the treatment fluid.

The treatment fluid package may include a friction reducer package (including a friction reducer, a suspension package, and nanoparticles), a biocide (or a biofilm remover), and a scale inhibitor. Each of the friction reducer package, the biocide, and the scale inhibitor may be present in a single package including the treatment fluid package to facilitate reducing a volume of inactive ingredients that are used for providing conventional additives to a wellsite. Since each of the friction reducer package, the biocide, and the scale inhibitor are present in a single fluid volume of the treatment fluid package, the volume of solvents and/or carrier fluids for providing the active components (e.g., the active components of the friction reducer package, the biocide, and the scale inhibitor) may be reduced compared to treatment fluids formed from additives that are provided separately to the treatment fluid. Accordingly, the treatment fluid package may include a higher volume percent and/or weight percent of active components than other treatment fluids formed from separate packages of additives. For example, a volume percent and/or weight percent of the sum of the friction reducer, the biocide, and the scale inhibitor may be greater than the volume percent of the sum of such components when such components are added to the treatment fluid separately with different solvents and/or carrier fluids.

The friction reducer package may include a friction reducer, nanoparticles, and a suspension package formulated and configured to facilitate the flowability of the friction reducer and the nanoparticles. The friction reducer may include a polymeric material. In some embodiments, the friction reducer comprises, consists essentially of, or consists of polyacrylamide (PAM).

The friction reducer may constitute from about 50.0 volume percent to about 95.0 volume percent of the friction reducer package, such as from about 50.0 volume percent to about 60.0 volume percent, from about 60.0 volume percent to about 70.0 volume percent, from about 70.0 volume percent to about 80.0 volume percent, from about 80.0 volume percent to about 90.0 volume percent, or from about 90.0 volume percent to about 95.0 volume percent of the friction reducer package. The friction reducer may constitute greater than about 60.0 volume percent, such as greater than about 70.0 volume percent, greater than about 80.0 volume percent, or even greater than about 90.0 volume percent of the friction reducer package. In some embodiments, the friction reducer constitutes greater than about 80.0 volume percent of the friction reducer package. A relatively high volume percent of the friction reducer in the friction reducer package may reduce the relative amount of the suspension package and increase a content of active component (e.g., the friction reducer) in the friction reducer package.

The nanoparticles may be formulated and configured to facilitate the recovery of the friction reducer after circulating a treatment fluid including the treatment fluid package through the wellbore 302 and portions of the earth formation 303. The nanoparticles may have a spherical shape, a plate shape, a cylindrical shape, a cuboid shape, or another shape. In some embodiments, the nanoparticles are spherical.

An average size (e.g., largest dimension, diameter) of the nanoparticles may be within a range of from about 1.0 nm to about 1,000 nm (about 1.0 μm), such as from about 1.0 nm to about 5.0 nm, from about 5.0 nm to about 10.0 nm, from about 10.0 nm to about 20.0 nm, from about 20.0 nm to about 50.0 nm, from about 50.0 nm to about 100 nm, from about 100 nm to about 200 nm, from about 200 nm to about 500 nm, or from about 500 nm to about 1,000 nm. In some embodiments, the nanoparticles have an average size within a range of from about 1.0 nm to about 100 nm.

In some embodiments, the nanoparticles include silica nanoparticles, such as those commercially available from Nissan Chemical America Corporation of Houston, Texas.

The nanoparticles may constitute from about 0.5 weight percent to about 10.0 weight percent of the friction reducer package, such as from about 0.5 weight percent to about 1.0 weight percent, from about 1.0 weight percent to about 2.0 weight percent, from about 2.0 weight percent to about 4.0 weight percent, from about 4.0 weight percent to about 6.0 weight percent, from about 6.0 weight percent to about 8.0 weight percent, or from about 8.0 weight percent to about 10.0 weight percent of the friction reducer package. However, the disclosure is not so limited, and the nanoparticles may constitute a different amount of the friction reducer package than that described.

In some embodiments, the friction reducer package comprises an emulsion. For example, the friction reducer and the nanoparticles may be emulsified in the suspension package. In some embodiments, the friction reducer and the nanoparticles comprise a discontinuous phase in a continuous phase comprising the suspension package.

The suspension package may be formed of and include a material exhibiting circular chemistry. In other words, the suspension package may each include materials that may be part of a circular and sustainable cycle, facilitating a reduction in the generation of waste materials. In some embodiments, the suspension package is formed of and includes materials that are considered waste materials in other industries and/or other industrial processes.

The suspension package may include, for example, one or more fatty acids. In some embodiments, the suspension package includes fatty acids, such as one or more of C₁₆ fatty acids and/or C₁₈ fatty acids. The fatty acids may be saturated, unsaturated, or may include a mixture of saturated and unsaturated fatty acids. In some embodiments, the suspension package comprises one or more of palmitic acid, stearic acid, oleic acid, and linoleic acid. In some embodiments, the suspension package comprises each of palmitic acid, stearic acid, oleic acid, and linoleic acid. In some embodiments, the suspension package comprises rosella oil (also referred to as roselle seed oil, hibiscus sabdariffa seed oil) including from about 35.0 weight percent to about 45.0 weight percent linoleic acid, from about 25.0 weight percent to about 35.0 weight percent of oleic acid, from about 15.0 weight percent to about 25.0 weight percent of palmitic acid, and from about 3.0 weight percent to about 10.0 weight percent of stearic acid.

In some embodiments, the suspension package includes from about 36.0 weight percent to about 38.0 weight percent linoleic acid, such as about 37.0 weight percent linoleic acid; from about 31.0 weight percent to about 33.0 weight percent oleic acid, such as about 32.0 weight percent oleic acid; from about 18.0 weight percent to about 20.0 weight percent palmitic acid, such as about 19.0 weight percent palmitic acid; and from about 3.0 weight percent to about 5.0 weight percent stearic acid, such as about 4.0 weight percent stearic acid. The suspension package may include additional acids, such as myristic acid, palmitoleic acid, and/or linolenic acid. In some embodiments, the suspension package includes about 18.9 weight percent or 19.0 weight percent palmitic acid, about 37.5 weight percent or 37.6 weight percent linoleic acid, about 31.9 weight percent or 32.0 weight percent oleic acid, and about 4.0 weight percent or 4.1 weight percent stearic acid.

The suspension package may improve the flowability (e.g., the rheology) of the friction reducer package and the treatment fluid including the treatment fluid package. In some embodiments, the suspension package may provide elasticity to the friction reducer package and the treatment fluid. In some embodiments, the suspension package may improve the flowability of the treatment fluid to portions of the wellbore 302 and/or earth formation 303, such as different portions of the wellbore 302 and/or the earth formation 303 within the deviated portions 306. In some embodiments, the suspension package may reduce settling of the friction reducer package and the treatment fluid in portions of the wellbore 302 and/or earth formation 303 to the detriment of other portions of the wellbore 302 and/or the earth formation 303.

The suspension package may constitute from about 10.0 volume percent to about 50.0 volume percent of the friction reducer package, such as from about 10.0 volume percent to about 20.0 volume percent, from about 20.0 volume percent to about 30.0 volume percent, from about 30.0 volume percent to about 40.0 volume percent, or from about 40.0 volume percent to about 50.0 volume percent of the friction reducer package. In some embodiments, the suspension package constitutes less than about 40.0 volume percent of the friction reducer package, such as less than about 30.0 volume percent, less than about 25.0 volume percent, less than about 20.0 volume percent, or even less than about 15.0 volume percent of the friction reducer package. However, the disclosure is not so limited, and the suspension package may constitute a different volume percent of the friction reducer package than that described.

The composition of the friction reducer and the suspension package may facilitate the flowability of the friction reducer in the friction reducer package at relatively higher concentrations of the friction reducer compared to other friction reducers. The relatively higher concentration of the friction reducer in the friction reducer package facilitates increasing the concentration of the active component (e.g., the friction reducer) in the friction reducer package compared to other friction reducers.

The friction reducer package may constitute from about 50.0 volume percent to about 95.0 volume percent of the treatment fluid package, such as from about 50.0 volume percent to about 60.0 volume percent, from about 60.0 volume percent to about 70.0 volume percent, from about 70.0 volume percent to about 80.0 volume percent, from about 80.0 volume percent to about 90.0 volume percent, or from about 90.0 volume percent to about 95.0 volume percent of the treatment fluid package. The friction reducer package may constitute greater than about 60.0 volume percent, such as greater than about 70.0 volume percent, greater than about 80.0 volume percent, or even greater than about 90.0 volume percent of the treatment fluid package. In some embodiments, the friction reducer package constitutes a majority of the treatment fluid package, such as greater than 50.0 volume percent of the treatment fluid package.

As described above, in addition to the friction reducer package, the treatment fluid package may further include the biocide and the scale inhibitor. The biocide may include one or more materials formulated and configured to denature biofilm (a layer of microorganisms that grows and sticks on surfaces, such as downhole tools and components, piping, tubing, etc.). In some embodiments, the biocide includes an organic material comprising one or more proteins formulated and configured to denature biofilms. In some embodiments, the biocide includes a naturally occurring material. In some such embodiments, since the biocide includes an organic material and/or one or more proteins, the biocide may not be required to be registered with regulatory agencies.

The biocide may constitute from about 0.5 volume percent to about 5.0 volume percent of the treatment fluid package, such as from about 0.5 volume percent to about 1.0 volume percent, from about 1.0 volume percent to about 2.0 volume percent, from about 2.0 volume percent to about 3.0 volume percent, from about 3.0 volume percent to about 4.0 volume percent, or from about 4.0 volume percent to about 5.0 volume percent of the treatment fluid package. However, the disclosure is not so limited, and the biocide may constitute a different amount of the treatment fluid package.

The scale inhibitor may include a polymeric material that is compatible with the friction reducer and the friction reducer package. The scale inhibitor may be tailored to be compatible with properties of the earth formation 303. In some embodiments, the scale inhibitor is provided to the treatment fluid package at a concentration of active component greater than about 50.0 volume percent, such as greater than about 55.0 volume percent, greater than about 60.0 volume percent, greater than about 70.0 volume percent, or even greater than about 80.0 volume percent. By way of comparison, other scale inhibitors may be provided to a wellbore fluid at a concentration of active components of only about 5.0 volume percent.

The scale inhibitor may exhibit synergistic properties with the friction reducer and may be formulated and configured to reduce a drag (e.g., fluid resistance) of the friction reducer. In some embodiments, the scale inhibitor is formulated and configured such that the treatment fluid package exhibits viscoelastic properties. For example, the treatment fluid package may exhibit viscous (e.g., fluid-like) properties and elastic (e.g., solid-like) properties to facilitate the flowability of the treatment fluid package. In some embodiments, the viscoelasticity of the treatment fluid package facilitates delivery of the treatment fluid package to deeper portions of the wellbore 302 and/or the earth formation 303 (e.g., portions located farther from the surface).

The scale inhibitor may constitute from about 0.5 volume percent to about 5.0 volume percent of the treatment fluid package, such as from about 0.5 volume percent to about 1.0 volume percent, from about 1.0 volume percent to about 2.0 volume percent, from about 2.0 volume percent to about 3.0 volume percent, from about 3.0 volume percent to about 4.0 volume percent, or from about 4.0 volume percent to about 5.0 volume percent of the treatment fluid package. However, the disclosure is not so limited, and the scale inhibitor may constitute a different amount of the treatment fluid package.

The treatment fluid package may include greater than about 70.0 volume percent active components. The active components may include the friction reducer, the nanoparticles, the biocide, and the scale inhibitor. In some embodiments, the treatment fluid package includes greater than about 75.0 volume percent actives, such as greater than about 80.0 volume percent actives, or even greater than about 85.0 volume percent actives.

In some embodiments, the suspension package constitutes from about 5.0 volume percent to about 40.0 volume percent of the treatment fluid package, such as from about 5.0 volume percent to about 10.0 volume percent, from about 10.0 volume percent to about 15.0 volume percent, from about 15.0 volume percent to about 20.0 volume percent, from about 20.0 volume percent to about 25.0 volume percent, from about 25.0 volume percent to about 30.0 volume percent, from about 30.0 volume percent to about 35.0 volume percent, or from about 35.0 volume percent to about 40.0 volume percent of the treatment fluid package. In some embodiments, the suspension package constitutes less than about 40.0 volume percent of the treatment fluid package, such as less than about 35.0 volume percent, less than about 30.0 volume percent, less than about 25.0 volume percent, less than about 20.0 volume percent, less than about 15.0 volume percent, or even less than about 10.0 volume percent of the treatment fluid package. However, the disclosure is not so limited, and the suspension package may constitute a different amount of the treatment fluid package than that described.

In some embodiments, the treatment fluid package further includes one or more additional additives, such as one or more of a corrosion inhibitor, a gelling agent, a crosslinker, a breaker, or an acid. The one or more additional additives may be present in the treatment fluid package, or may be provided to the treatment fluid separately from the treatment fluid package.

The treatment fluid package may constitute from about 0.5 volume percent to about 10.0 volume percent of the treatment fluid (wellbore fluid), such as from about 0.5 volume percent to about 1.0 volume percent, from about 1.0 volume percent to about 2.0 volume percent, from about 2.0 volume percent to about 4.0 volume percent, from about 4.0 volume percent to about 6.0 volume percent, from about 6.0 volume percent to about 8.0 volume percent, or from about 8.0 volume percent to about 10.0 volume percent of the treatment fluid. In some embodiments, the treatment fluid package constitutes from about 0.5 volume percent to about 5.0 volume percent of the wellbore fluid. However, the disclosure is not so limited, and the treatment fluid package may constitute a different amount of the treatment fluid.

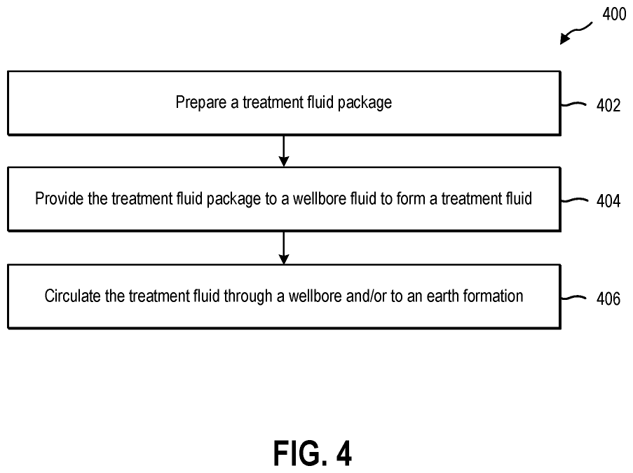

FIG. 4 is a simplified flow diagram of a method of treating a wellbore and/or earth formation with a treatment fluid, according to at least one embodiment of the present disclosure. The method 400 may include preparing a treatment fluid package, as shown in act 402. The treatment fluid package may be the same as the treatment fluid package described above and may include a friction reducer package (including a friction reducer, nanoparticles, and a suspension package), a biocide, and a scale inhibitor.

The method 400 may further include providing the treatment fluid package to a wellbore fluid to form a treatment fluid, as shown in act 404. Providing the treatment fluid package to a wellbore fluid may include mixing the treatment fluid package with the wellbore fluid, such as a hydraulic fracturing fluid. The wellbore fluid may include one or more of a hydraulic fracturing fluid, a pumpdown fluid, an acid (e.g., a spearhead treatment), a stimulation fluid, a completion fluid, a corrosion inhibitor composition, another fluid to be provided to the wellbore 302 and/or the earth formation 303. In some embodiments, the wellbore fluid includes a hydraulic fracturing fluid. In some embodiments, the treatment fluid package is provided to the wellbore fluid as a package such that all of the components of the treatment fluid package are provided to the wellbore fluid together. In some embodiments, the treatment fluid package includes a single solvent or carrier fluid that is compatible with each of the additives (e.g., each of the friction reducer, the nanoparticles, the biocide, and the scale inhibitor). The treatment fluid package may exhibit multiple functionalities. For example, the treatment fluid package may reduce a friction (e.g., include the friction reducer) and may reduce gelling. In some embodiments, the treatment fluid package may facilitate acid retarding, iron-reduction, emulsion inhibition and corrosion, and/or may include a surfactant and/or an inhibition aid.

After providing the treatment fluid package to a wellbore fluid to form the treatment fluid, the method 400 further includes circulating the treatment fluid including the treatment fluid package through a wellbore and/or to an earth formation through which the wellbore extends, as shown in act 406. For example, the treatment fluid may be pumped from a surface to the wellbore and to the earth formation. Circulation of the treatment fluid may include pumping the treatment fluid to the wellbore, and back to the surface through, for example, an annular region between a string or liner and surfaces of the earth formation defining the wellbore. Circulation of the treatment fluid through the wellbore and to the earth formation may include treating the wellbore and/or the earth formation with the treatment fluid.

Accordingly, the treatment fluid package may facilitate increasing the percent of active ingredients provided to the treatment fluid and may reduce the cost of transportation and storage of additives provided to the wellbore fluid to form the treatment fluid. Providing a single composition that includes the treatment fluid package improves the provision of additives having different functionalities (e.g., friction reducers, biocides, scale inhibitors, and any additional additives (e.g., gelling agents, acid retarders, iron-reducing agents, non-emulsifying agents, surfactants, inhibitor aids, corrosion inhibitors, etc.)) to the treatment fluid compared to providing each additive separately with a solvent or carrier fluid for each separate additive.

The specific embodiments described above have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform] ing [a function] . . . , ”, it is intended that such elements are to be interpreted under 35 U.S.C. 112(f). However, for any claims containing elements designated in any other manner, it is intended that such elements are not to be interpreted under 35 U.S.C. 112(f).

The embodiments of treatment fluid packages and the wellbore fluids including the treatment fluid packages have been primarily described with reference to borehole and wellbore drilling operations; the wellbore fluids described herein may be used in applications other than the drilling of a wellbore or borehole. In other embodiments, treatment fluid packages and the wellbore fluids according to the present disclosure may be used outside a wellbore, borehole, or other downhole environment used for the exploration or production of natural resources. Accordingly, the terms “wellbore,” “borehole,” and the like should not be interpreted to limit tools, systems, assemblies, or methods of the present disclosure to any particular industry, field, or environment. In addition, the wellbore fluids may be used in cased completion wellbores and in open hole completion wellbores.

In some embodiments, the wellbore fluids may be used during formation of a borehole and/or wellbore to be used for carbon capture, utilization, and storage (CCUS) and/or for recovery and use of geothermal energy. Geothermal energy is a promising source of renewable energy that captures energy from heat generated within the earth. For example, geothermal energy may be used to heat structures (e.g., buildings) and/or to generate electricity (e.g., by heating water to generate steam and drive a turbine with the steam). The wellbore fluids described herein may be used to form boreholes and/or wellbores used to circulate a fluid that is heated within the earth formation through which the borehole and/or wellbore extends. The heated fluid may be circulated to the surface where the captured heat may be recovered to heat a structure and/or generate electricity, followed by recirculation of the fluid to the earth formation to continue the cycle.

CCUS facilitates the capture, use, and/or storage of carbon (e.g., carbon dioxide), which has a goal of achieving carbon neutrality and/or net zero carbon emissions (NZE). CCUS may facilitate the capture of carbon dioxide from large point sources (e.g., power plants, refineries, cement plants, other industrial processing plants, or other industrial facilities that use fossil fuels, biomass fuels, or other fuels that generate carbon dioxide). The captured carbon dioxide may be converted into valuable products such as, for example, ethanol, sustainable aviation fuel, chemicals, and mineral aggregates. Alternatively, the carbon dioxide may be stored in geologic formations, such as in depleted hydrocarbon reservoirs. The carbon dioxide may be introduced into the earth formation through a borehole and/or wellbore formed using the drilling fluids described herein. In the earth formation, the carbon dioxide may be dispersed in an aqueous phase and stored as carbon dioxide, in mineral form (e.g., as a carbonate, such as calcium carbonate, magnesium carbonate, iron(II) carbonate), or as another form of carbon.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of providing a multifunctional treatment fluid package to a wellbore, the method comprising:
providing a multifunctional treatment fluid package to a wellsite, the multifunctional treatment fluid package comprising:
a friction reducer package comprising:
greater than about 70.0 volume percent of a friction reducer comprising polyacrylamide;
nanoparticles; and
a suspension package comprising an organic oil including one or more fatty acids;
a biocide; and
a scale inhibitor;
mixing the multifunctional treatment fluid package with a fluid to form a treatment fluid; and
circulating the treatment fluid to a wellbore extending through a subterranean formation.

2. The method of claim 1, wherein mixing the multifunctional treatment fluid package with a fluid comprises mixing the multifunctional treatment fluid package with a fracturing fluid.

3. The method of claim 1, further comprising fracturing a portion of the subterranean formation with the treatment fluid.

4. The method of claim 1, wherein the friction reducer constitutes greater than about 80.0 volume percent of the friction reducer package.

5. The method of claim 1, wherein the friction reducer package constitutes greater than about 70.0 volume percent of the multifunctional treatment fluid package.

6. The method of claim 1, wherein the suspension package comprises rosella oil.

7. The method of claim 1, wherein the suspension package comprises a mixture of:
palmitic acid;
stearic acid;
oleic acid; and
linoleic acid.

8. The method of claim 1, wherein the biocide includes an organic material formulated and configured to denature a biofilm.

9. The method of claim 1, wherein the scale inhibitor includes a polymeric material compatible with the friction reducer.

10. The method of claim 1, wherein the nanoparticles comprise silica nanoparticles.

11. A treatment fluid for treating a wellbore, the treatment fluid comprising:
a base fluid; and
a multifunctional treatment fluid package, comprising:
a friction reducer package comprising:
greater than about 70.0 volume percent of a friction reducer comprising polyacrylamide;
nanoparticles; and
a suspension package comprising an organic oil including one or more fatty acids;
a biocide; and
a scale inhibitor.

12. The treatment fluid of claim 11, wherein the base fluid includes a fracturing fluid comprising proppants.

13. The treatment fluid of claim 11, wherein the nanoparticles comprise silica nanoparticles.

14. The treatment fluid of claim 11, wherein the nanoparticles have an average size within a range of from about 1.0 nm to about 100 nm.

15. The treatment fluid of claim 11, wherein the nanoparticles constitute from about 0.5 weight percent to about 10.0 weight percent of the friction reducer package.

16. The treatment fluid of claim 11, wherein the organic oil includes rosella oil.

17. The treatment fluid of claim 11, wherein the scale inhibitor includes a polymeric material.

18. The treatment fluid of claim 11, wherein the biocide includes an organic material formulated and configured to denature a biofilm.

19. The treatment fluid of claim 11, wherein the multifunctional treatment fluid package constitutes from about 0.5 volume percent to about 5.0 volume percent of the treatment fluid.

20. A multifunctional treatment fluid package for use in a wellbore treatment fluid, the multifunctional treatment fluid package comprising:
a friction reducer package comprising:
greater than about 70.0 volume percent of a friction reducer comprising polyacrylamide;
nanoparticles; and
a suspension package comprising an organic oil including one or more fatty acids;
a biocide; and
a scale inhibitor.
